(19) United States
(12) Patent Application Publication
(10) Pub. No.: US 2021/0182924 A1
(43) Pub. Date: Jun. 17, 2021

(54) PROPERTY MAINTENANCE SERVICE MATCHING SYSTEM AND METHOD

(71) Applicant: The Lazy App, LLC, Detroit, MI (US)

(72) Inventor: Steven Reed, Detroit, MI (US)

(21) Appl. No.: 16/711,918

(22) Filed: Dec. 12, 2019

(51) Int. Cl. G06Q 30/06; G06Q 30/08; G06Q 10/10; G06Q 10/02; G06Q 20/14; G06Q 20/08; G06Q 30/02; G06Q 10/06; G06Q 30/00; G06Q 40/08; G06Q 10/00; G06F 21/45

(52) U.S. Cl. CPC G06Q 30/0605; G06Q 30/08; G06Q 10/10; G06Q 10/02; G06Q 20/14; G06F 21/45; G06Q 30/0282; G06Q 10/063114; G06Q 30/0185; G06Q 40/08; G06Q 10/20; G06Q 20/085

(57) ABSTRACT

A system and method is disclosed for matching service requests from a plurality of users with one provider from a plurality of providers. The system has a plurality of user electronic devices (“UED”), a plurality of provider electronic devices (“PED”), a communications network, a server, and a database. The method has a user process, a provider process, and an intermediating process. The intermediating process takes service requests made from users who are in an Active User Universe and places them on a list of active service requests. The intermediating process allow providers who are in an Active Provider Universe to view list of active service requests. A provider in the Active Provider Universe may select a service request, where upon the intermediating process removes that service request from a list of active service requests.

### FIELD OF INVENTION

This invention relates to the class of data processing systems or methods, specially adapted for administrative, commercial, financial, managerial, supervisory or forecasting purposes; and to one or more sub-classes related to forecasting or optimization; commerce; or systems or methods specially adapted for specific business sectors. Specifically, this invention relates to systems and methods to match property owners with property maintenance service providers.

### BACKGROUND OF INVENTION

Home-owners, landlords, and property management companies all face a similar challenge. Maintaining their property, both outdoors and indoors. Outdoor maintenance may include, but is not limited to, mowing grass; raking leaves; weeding; pruning trees; fertilizing grass; putting herbicide and pesticide on grass; removing snow from driveways, parking areas, and sidewalks; painting; cleaning windows; cleaning gutters; cleaning chimneys; caulking; placing and removing screens; winterizing external faucets and sprinkler systems; and performing minor repairs. Indoor maintenance may include, but is not limited to, cleaning floors and other surfaces; cleaning windows; cleaning carpets; cleaning bathrooms; painting; caulking; changing light bulbs; changing air filters; and performing minor repairs.

Many home-owners handle these routine maintenance issues themselves. However, due to time-constraints, work, family obligations, health, or physical condition, a home-owner may sometimes be unable to perform their normal maintenance. If the impediments to performing needed maintenance persists, this leads to their property falling into minor disrepair.

Many landlords and property management companies either perform these routine maintenance issues themselves, or they hire people to perform the tasks for them. Even when a person or company is specifically employed to perform these maintenance tasks, the issues of time-constraints, workload, family obligations, and health or physical condition can often leave maintenance unperformed. A backlog of maintenance can lead to expensive overtime and, in the extreme, property damage as the property falls into disrepair.

Scheduling maintenance services, such as landscaping, from an external contractor is often time-consuming. The property owner has to find someone who is willing to perform the work on a reasonable schedule. Insurance, experience, work quality, price, and geography often complicate the issue further. Additionally, many laborers willing and able to perform these routine maintenance tasks have no effective means for gaining traction in the market. The difficulties in finding a sustainable customer base inhibits laborers from working for themselves. The difficulties in finding a sustainable customer base also inhibits maintenance companies from expanding their staff and geographic reach.

The market is in need of an invention that more effectively allows property owners and laborers to find each other in real-time

### SUMMARY OF THE INVENTION

This summary is intended to disclose the present invention, a real-time system and method for matching property maintenance service requests with property maintenance service providers. The embodiment and description are used to illustrate the invention and its utility and are not intended to limit the invention or its use. The following presents a simplified summary of the primary embodiment of the invention to provide a basic understanding of the invention. Additional concepts that can be added or varied with the primary embodiment are also disclosed. The present invention is novel with respect to the prior art, and can be distinguished from the prior art.

In general, the present invention is a system and method for matching service requests (“Service Requests”) from users (“Users”) will service providers (“Providers”) capable of performing the Service Request.

The process uses two separate real-time processes that are intermediated by a third real-time process, in order to match property maintenance service requests with property maintenance service provider. A first process allows a User to make a Service Request. A second process allows a Provider to express their availability to perform the Service Request. An intermediating process (“Intermediating Process”) matches a plurality of Service Requests from a plurality of Users with Providers using a constraint matching algorithm.

The system is comprised of a plurality of User Electronic Devices (“UED”); a plurality of Provider Electronic Devices (“PED”); a server, communications channels between each UED and PED and the server; a database, comprised of a non-transitory computer-readable media that is connected to the server; an executable instruction set (“User App”) stored on non-transitory computer-readable media and accessible to each UED; an executable instruction set (“Provider App”) stored on non-transitory computer-readable media and accessible to each PED; and an executable instruction set (“Intermediating App”) stored on non-transitory computer-readable media and accessible to the server. The User App, Provider App, and Intermediating App interoperate in order to match Service Requests with Providers.

The first process is a User Process to create Service Requests. Before making a Service Request, the User must register, creating a user name, selecting a user password, and establishing a profile (“User Profile”). A User Profile contains, at a minimum, information about the User, information about any contact person to whom the Provider should report when performing service, information about the property to be maintained, payment information, and user preferences. This information is referred to as attributes. User preferences include default filters, including, but not limited to, setting the service time, skill-level, maximum hourly charge for each type of Service Request, experience requirements, insurance, and license information. Once a User is registered, the User may access the real-time User Process using a UED. The UED includes, but is not limited to, mobile devices, computers, tablets, smart TVs, personal electronic assistants such as Alexa®, or an internet-connected appliance.

The User Process is embodied in the User App, an executable instruction set stored on a non-transitory, computer-readable medium accessible to the UED. In the exemplary embodiment, the User App is stored on the UED in a non-transitory, computer-readable medium. The User Process has both sequential and non-sequential steps.

The sequential portion of the User Process comprises the steps of logging, connecting to the Intermediating Process, creating a Service Request, communicating Service Request to the Intermediating Process, receiving a proposed Provider (“Service Proposal”) from the Intermediating Process, confirming service with the Intermediating Process, receiving status from the Intermediating Process, having the Provider arrive at the property, having the Provider complete the Service Request, processing payment, and providing feedback.

The non-sequential portion of the User Process allows the User to access various information including, but not limited to, User bookings; User Profile; User payment methods; notifications; and report a problem. Notifications notify the User that there is a pending Service Proposal, communicates advertising to the User, notifies a User of their current feedback provided by Providers, and informs the Users about changes to the User App and the terms and conditions of use.

The second process is a Provider Process, which allows a Provider to find work. Prior to using the Provider Process, the Provider must register, creating a provider user name, selecting a Provider password, and establishing a Provider profile (“Provider Profile”). A Provider Profile contains, at a minimum, information about the Provider, including, but not limited to, the Provider's skill areas, the types of jobs the Provider is willing to perform, the Provider's experience level, the Provider's geographic work areas, the Provider's hourly rate, and the Provider's licensing and insurance information. This information is referred to as attributes.

Once a Provider is registered, the Provider may access a real-time matching process using a PED. The PED includes, but is not limited to, mobile devices, computers, tablets, smart TVs, personal electronic assistants such as Alexa®, or an internet-connected appliance.

The Provider Process is embodied in an executable instruction set (“Provider App”) stored on a non-transitory, computer-readable medium accessible to the PED. In the exemplary embodiment, the Provider process is stored on the PED in a non-transitory, computer-readable medium. The Provider Process comprises both sequential and non-sequential steps.

The Provider Process comprises the sequential steps of logging, connecting to the Intermediating Process, viewing Service Requests, selecting Service Requests from the Intermediating Process, accepting or rejecting Service Proposals from the Intermediating Process, confirming service with the Intermediating Process, viewing service details, allowing PED to provide location and status, arriving at service location, performing service, receiving payment, and providing feedback.

The non-sequential portion of the Provider Process allows the Provider to access various information including, but not limited to, Provider bookings; Provider Profile; Provider payment preference; Provider earnings; notifications; and report a problem. Provider Profile allows the Provider to change information in the Provider's Profile, including service area geography, rate of pay, services provided, and experience. Notifications notify the Provider that a booking has been created from a Service Proposal, allows a Provider to advertise to potential users, notifies a Provider on their current feedback from Users, and informs the Providers about any software changes or changes in terms of service.

The Intermediating Process interacts with the User Process, and the Provider Process. Broadly stated, the Intermediating Process matches Service Requests from Users with Providers that can perform the Service Requests. The Intermediating Process communicates with a plurality of UEDs and a plurality of PEDs using a combination of wi-fi, cellular communications, internet, and satellite.

The Intermediating Process has a run-time loop and a utility function. The Intermediating Process has a user library comprised of a plurality of user profiles and a provider library comprised of a plurality of provider profiles. The Intermediating Process has a permanent run-time loop. The utility functions of the Intermediating Process are accessed with an administrative login. The Intermediating Process receives logins from a plurality of Users and a plurality of Providers. The Intermediating Process enters the logged Providers into a matching universe. A logged User may enter a Service Request. The Intermediating Process interprets a Service Request by a set of requirements: service type; maximum payment per hour; geographic location; and experience, licensing, and insurance requirements. The Intermediating Process identifies all the Providers in the matching universe (“Qualified Provider”) capable of performing the Service Request. The Intermediating Process will allow each Qualified Provider to see each Service Request for which they are qualified. The Intermediating Process allows each Provider in the matching universe to select one or more Service Requests in the matching universe. The Intermediating Process then sends a notification to the User of each selected Service Request. The User that selects a particular Provider (“Target Provider”) first is assigned that Provider. The Target Provider is temporarily removed from the matching universe. The Intermediating Process sends the Target Provider a Service Proposal. A Service Request remains in the matching universe until both the User and Target Provider have accepted the Service Proposal related to the Service Request. When both the User and the Target have accepted the Service Proposal, the User's Service Request is removed from the matching universe and a booking is made.

The Intermediating Process tracks the location of the Target Provider, tracks the time on the job, creates an invoice for the job when it is completed, charges the User's payment method, and enters any feedback into the record of the User and Provider.

### BRIEF DESCRIPTION OF THE DRAWINGS

This application is disclosed with five figures on five sheets.

FIG. 1 is a high-level system architecture.

FIG. 2 is a high-level process chart.

FIG. 3 is a flow-chart of the User Process.

FIG. 4. is a flow-chart of the Provider Process.

FIG. 5 is a flow-chart of the Intermediating Process run-time loop.

FIG. 6 is a flow-chart of the Intermediating Process utility function.

### DETAILED DESCRIPTION OF THE DRAWINGS

The following descriptions are not meant to limit the invention, but rather to add to the summary of invention, and illustrate the present invention 1, a system and method for matching property maintenance Service Requests with Providers. The present invention 1 is illustrated with five figures showing the primary embodiment of the present invention, with examples presented of the various form-factors that the present invention can take. Important variations, or embodiments, are also discussed.

Certain terminology is used in the following description for convenience only and is not intended to be limiting. The article “a” is intended to include one or more items, and where only one item is intended the term “one” or similar language is used. Additionally, to assist in the description of the present invention, words conveying a temporal or processing relationship such as before, after, and next are used to describe the accompanying figures. The terminology includes the words above specifically mentioned, derivatives thereof, and words of similar import.

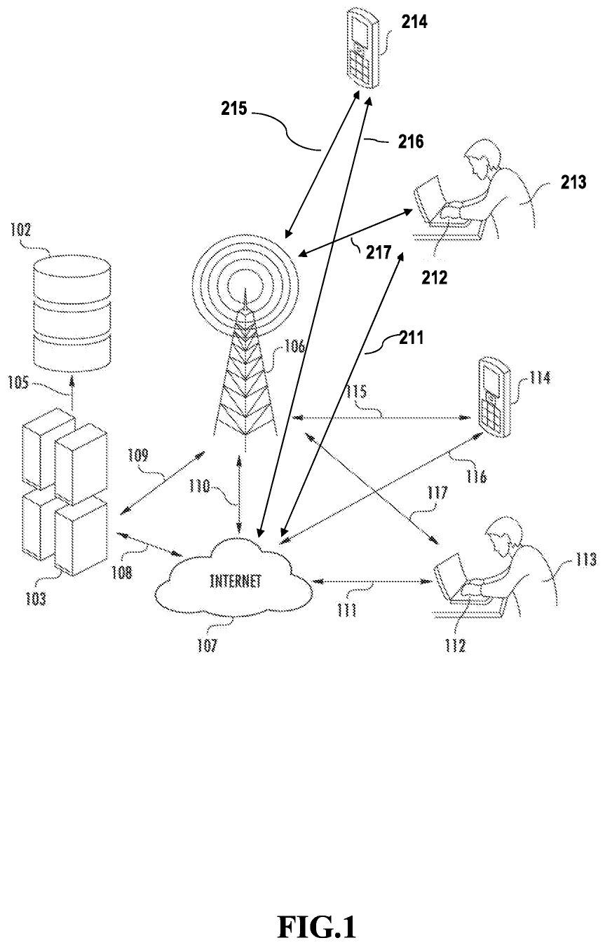

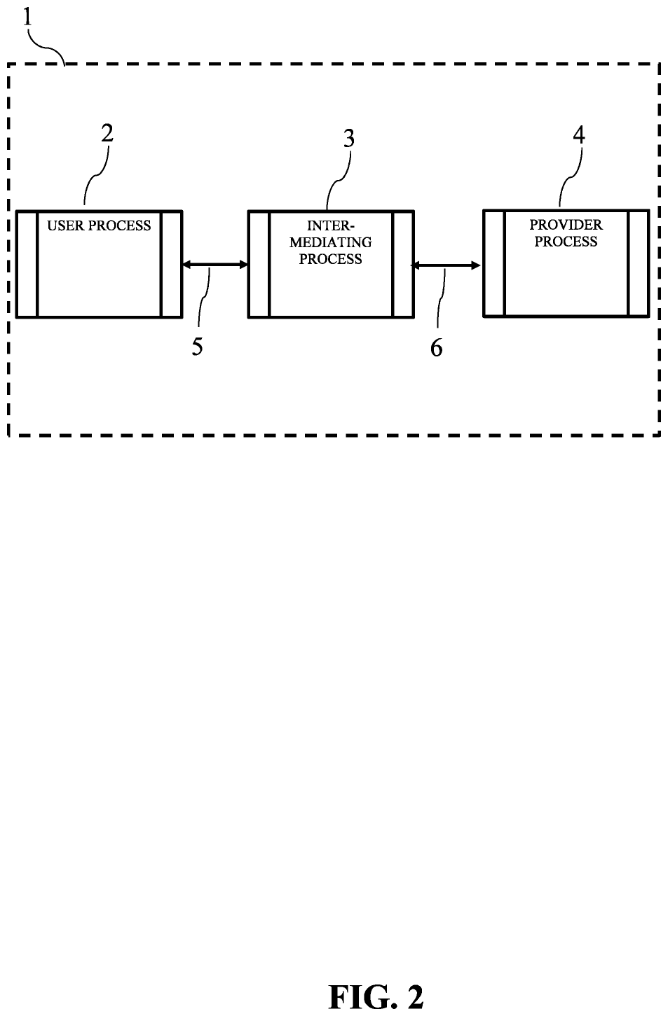

Referring to FIGS. 1 and 2, the present invention 1, uses two separate real-time processes 2, 4 that are intermediated by a third real-time process 3, in order to match property maintenance Service Requests with. A first process, the User Process 2, is used to make Service Requests. A second process, the Provider Process 4, is used to show Service Requests to a plurality of qualified Providers 113 and to allow each Provider 113 to express their availability to perform the Service Request. An Intermediating Process 3 matches a plurality of Service Requests from a plurality of Users 213 with one Provider 113 from a plurality of Qualified Providers 113 using a constraint matching algorithm. The User Process 2 interoperates 5 only with the Intermediating Process 3. The Provider Process 4 interoperates 6 only with the Intermediating Process 3. The Provider Process 4 and the User Process 2 never interoperate with one another.

FIG. 1 shows the system aspects of the present invention 1. The system of the present invention 1 is comprised of a plurality of UEDs 212, 214; a plurality of PEDs 112, 114; a communications network 107, 108, 109, 110, 111, 115, 116, 117, 211, 215, 216, 217; and a server 103; a database 102 that is accessible 105 to the server 103; wherein a User 213 can create a Service Request using a UED 212, 214 that will be matched with a Provider 113 using a PED 112, 114 capable of performing the Service Request.

A User 213 accesses the User Process 2 by using a UED 212, 214. The UED 212, 214 has a display, an input, a power source, a processing unit, RAM, and access to a non-transitory, computer-readable memory. UEDs include, but is not limited to, mobile devices such as cellphones 214, computers such as laptops 212, tablets, or desktop computers, smart TVs, personal electronic assistants such as Alexa®, or internet-connected appliances. The User Process 2 is embodied as a computer-readable and executable instruction set called the User App on the non-transitory, computer-readable memory accessible to the UED 212, 214.

The UED 212, 214 accesses the User Process 2 using the User App, which communicates using either a wired 211, 216 or wireless 215, 217 data network. Wireless data communication 215, 217 would use something like Wifi 106 or a cellular network 106. Wired data communication 211, 216 would be a direct connection to the internet 107 using something like ethernet cable. The data network may be a composite 110 of a wireless network 106 and the internet 107, with data streaming over both the wireless network 106 and the internet 107.

The User's 213 Service Request is routed 108, 109, 110 from the wired 211, 216 or wireless 215, 217 data network to a server 103. The server 103 has a processor, communication chip sets, RAM connected to the processor, and various interfaces. The server 103 is connected 105 to a non-transitory, computer-readable memory called a database 102. The Intermediating Process 3 is stored on the database 102 as a computer readable and executable instruction set.

In a similar manner, a Provider 113 accesses the Provider Process 4 by using a PED 112, 114. The PED 112, 114 has a display, an input, a power source, a GPS chip-set allowing for geolocation, a processing unit, RAM, and access to a non-transitory, computer-readable memory. PEDs 112, 114 include, but is not limited to, mobile devices such as cellphones 114, computers such as laptops 112, tablets, or desktop computers, smart TVs, personal electronic assistants such as Alexa®, or internet-connected appliances. The Provider Process 4 is embodied as a computer-readable and executable instruction set called the Provider App on the non-transitory, computer-readable memory accessible to the PED 112, 114.

The PED 112, 114 accesses the Provider Process 4 using the Provider App, which communicates using either a wired 111, 116 or wireless 115, 117 data network. Wireless data communication 115, 117 would use something like Wifi 106 or a cellular network 106. Wired data communication 111, 116 would be a direct connection to the internet 107 using something like ethernet cable. The data network may be a composite 110 of a wireless network 106 and the internet 107, with data streaming over both the wireless network 106 and the internet 107.

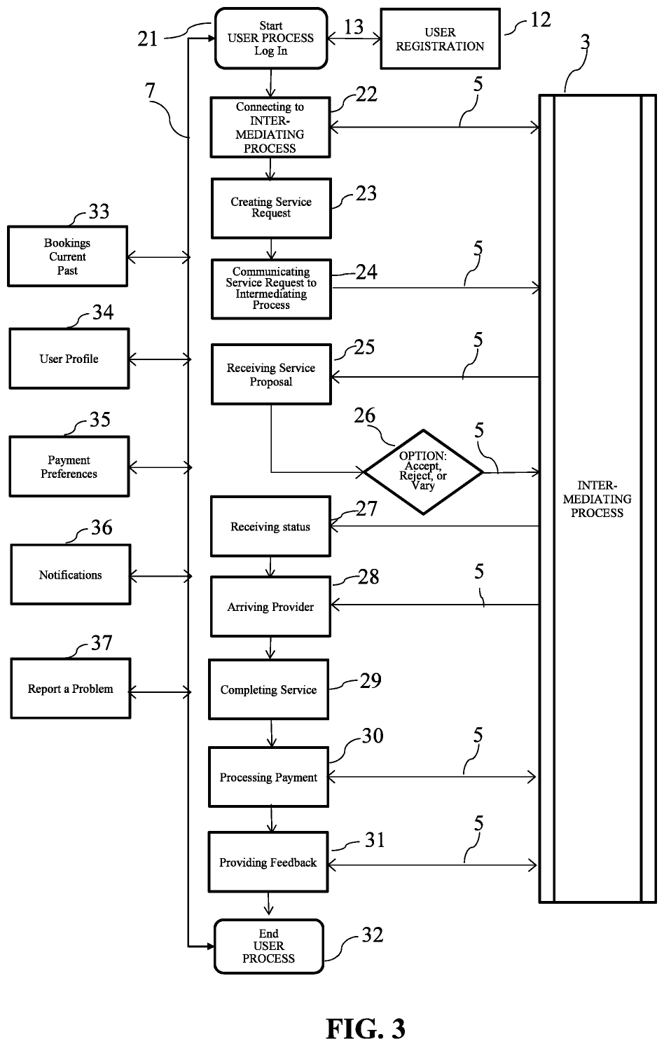

Referring to FIG. 3, prior to using the User Process 2, a User 213 must register 12, a one-time process 13. User Registration 12 comprises the steps of creating a user name, providing an e-mail address, selecting a user password, providing a profile picture, accepting the terms and conditions, and establishing a profile (“User Profile”) 34. A User Profile 34 contains, at a minimum, information about the User 213, information about any contact person to whom the Provider 113 should report when performing service, information about the property to be maintained, Payment Preferences 35, and user preferences. User preferences are stored as part of the User Profile 34 and are embodied as default filters, including, but not limited to, setting the service time, skill-level, maximum hourly charge for each type of Service Request, experience requirements, insurance, and license information. Service time may be set to immediately, within the next 2 hours, within the next 4 hours, today, tomorrow, this week, or user defined. If the user fails to set a user preference during Registration 12, the User 213 will be required to enter the appropriate user preferences prior to a Service Request being generated by the User Process 2.

Once a User 213 is registered, the User 213 may access the real-time User Process 2 using the User App and the UED 212, 214. In the exemplary embodiment, the User App is stored on the UED 212, 214 in a non-transitory, computer-readable medium. The User Process 2 has both sequential and non-sequential steps.

The sequential portion of the User Process 2 comprises the steps of logging 21, connecting to the Intermediating Process 22, creating a Service Request 23, communicating Service Request to the Intermediating Process 24, receiving a Service Proposal from the Intermediating Process 25, receiving status from the Intermediating Process 27, having the Provider arrive at the property 28, having the Provider complete the Service Request 29, processing payment 30, providing feedback 31, and closing the session 32. Optionally, the User Process 2 may include the ability of the User to accept, reject, or vary the Service Proposal 26

Connecting to the Intermediating Process 22 involves using a communication network 211, 215, 216, 217 such as Wi-Fi 106, cellular 106, the internet 107, satellite (not shown), or a combination 110, to create a data link between the UED 212, 214 and server 103 on which the Intermediating Process 3 resides, so that the User Process 2 and the Intermediating Process 3 may interoperate 5.

Creating a Service Request 23 entails selecting the type of service to be performed and answering the following, if the appropriate user preferences have not been previously set: setting a maximum price-per-hour; requesting a time of performance; and adjusting any default filters, if needed. For certain types of jobs, such as mowing lawns or cleaning houses, the User 213 may also need to provide a measure of the area to be serviced, such as square footage. In one embodiment, the User 213 will then be able to save the settings to user preferences in the User Profile 34, if desired.

The Service Proposal 25 from the Intermediating Process represents the first Provider 113 that accepts the User's 213 Service Request 23. In the primary embodiment, the User 213 may not reject the Service Proposal 25 or otherwise cancel the Service Request 23 once a Provider has accepted the Service Request 23. In an alternative embodiment, the User 213 may accept or reject 26 the Service Proposal 25 offered by the Intermediating Process 3. If the User 213 accepts 26 the Service Proposal 25, the User 213 will begin receiving status 27 updates. If the User 213 rejects 26 the Service Proposal 25, the Intermediating Process 3 will generate a new Service Proposal 25 with a new Provider 113, if one is available. In an alternative embodiment, the User 213 may also vary 26 the terms of the Service Proposal 25 of the Intermediating Process 3, thus constituting a counter-offer. A counter-proposal may be appropriate when the Service Proposal 25 does not meet all of the User preferences, such as time of performance, cost-per-hour, experience level, licensing information, or insurance requirements.

Receiving status 27 from the Intermediating Process 3 means that the User 213 is provided information about the Provider 113, including their name, a contact number, their profile picture, their rating, their current location, and the Provider's 113 estimated time of arrival at the property at which service is to be provided. The Provider's current location is provided by the GPS in the PED 112, 114.

Having the Provider 113 arrive 28 at the property is an event for the User Process 2. The GPS in the PED 112, 114 matches the GPS location of the location at which the service is to be provided. The UED 212, 214 receives a message from the Intermediating Process 3 stating that the Provider 113 has arrived. In one embodiment, both the User 213 and Provider 113 need to confirm the Provider's 213 arrival in order to begin the billing for the work to be performed. In an alternative embodiment, billing begins when the Provider 213 responds that the Provider 213 is at the service location. In an alternative embodiment, the Intermediating Process 3 begins the billing period automatically when the GPS in the PED 112, 114 matches the GPS coordinates for the service address.

Completion of the work 29 is an event to the User Process 2. In one embodiment, upon completion of the work 29, the User 213 receives a message from the Intermediating Process 4 asking if the work has been performed. The User 213 responds “yes” in order to terminate the billing interval for the work to be performed. In an alternative embodiment, the billing session ends when the Provider 113 ends the billing session. In an alternative embodiment, the billing session ends when the PED 112, 114 GPS coordinates no longer match the GPS coordinates of the service location.

After the billing session has ended, the User 213 receives an invoice from the Intermediating Process 3, which is automatically charged to the User's 213 payment method listed as a Payment Preference 35. The User 213 provides feedback 31 on the Provider 113 and the quality of work provided, if desired, and the work session ends 32. Feedback 31 can be a numerical rating, a letter grade, answers to survey questions, or selection of appropriate feedback from a list of possible feedback.

The non-sequential portion 7 of the User Process 2 allows the User 213 to access various information including, but not limited to, User bookings 33; User Profile 34; Payment Preferences 35; notifications 36; and report a problem 37. User bookings 33 includes both current bookings and past bookings. User bookings 33 allows the User 213 to select past booking service Providers 113 as either “prefer” or “avoid.” Users 213 may also select prior bookings as templates for creating a new Service Request 23. This is helpful for routine maintenance, such as cleaning, mowing, and weeding. User Profile 34 allows the User 213 to change information in the User Profile 34, including property location(s), contact person, and user preferences. Notifications 36 notify the User 213 of an event. Notifications 36 can notify the User 213 that there is a pending Service Proposal 25. Notifications 36 communicates advertising to the User 213, such as Providers 113 willing to perform work at a discount or Providers 113 who are immediately available for work of a certain type. Notifications 36 also notify a User 213 on their current feedback provided by Providers 113. Users 213 who routinely get negative feedback will find it difficult to have their Service Requests 23 fulfilled. Notifications 36 also informs the Users about software changes and changes in the terms and conditions of using the User App.

Report 37 a problem allows a User 213 to provide feedback concerning the User App, the terms and conditions of using the User App, or any other concern that the User 213 wishes to have addressed.

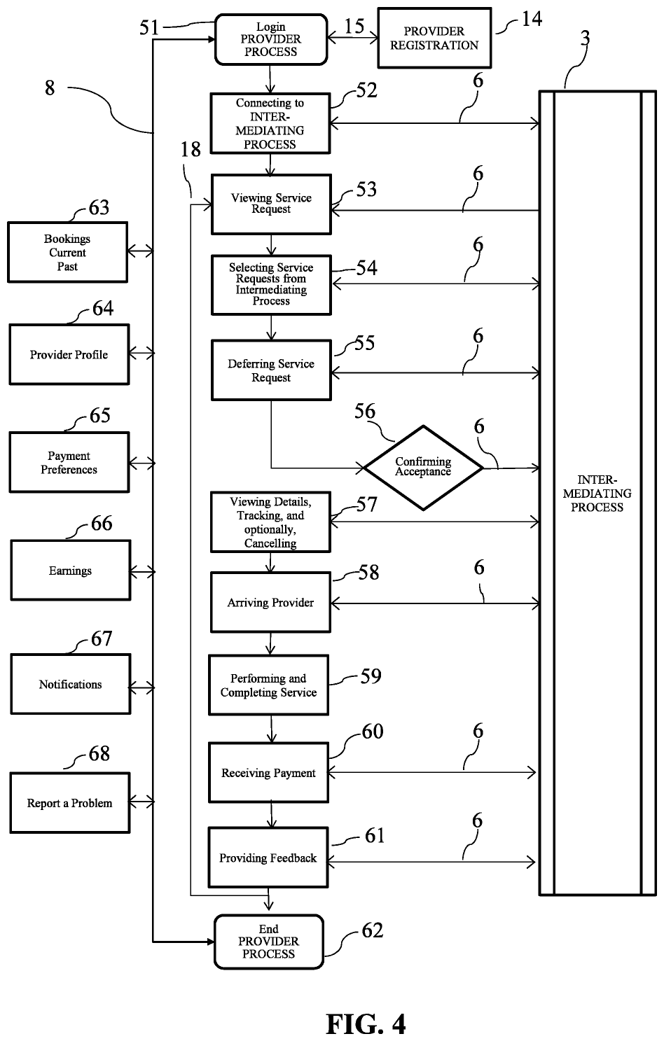

Referring to FIG. 4, prior to using the Provider Process 2, a Provider 113 must register 14, a one-time process 15. Provider Registration 14 comprises the steps of creating a Provider 113 user name, selecting a Provider 113 password, providing an e-mail address, providing a profile picture, accepting the terms and conditions, and establishing a Provider Profile 64. A Provider Profile 64 contains, at a minimum, information about the Provider 113, including, but not limited to, the Provider's skill areas, the types of jobs the Provider is willing to perform, the Provider's experience level, the Provider's geographic work areas, the Provider's hourly rate, and the Provider's licensing and insurance information.

Once a Provider is registered, the Provider may access a real-time matching process, called the Provider Process 4, using the Provider App on a PED 112, 114. The Provider Process 4 comprises both sequential and non-sequential 8 steps.

The Provider Process 4 comprises the sequential steps of logging 51, connecting to the Intermediating Process 52, viewing Service Requests 53, selecting Service Requests from the Intermediating Process 54, deferring Service Requests 55, confirming acceptance with Intermediate Process 56, viewing details, tracking through GPS on PED to provide location and status, and optionally cancelling 57, arriving at service location 58, performing service 59, receiving payment 60, providing feedback 61, and iterating 18 or ending session 62.

Connecting to the Intermediating Process 52 involves using a communication network 111, 115, 116, 117 such as Wi-Fi 106, cellular 106, the internet 107, satellite (not shown), or a combination 110, to create a data link between the PED 112, 114 and server 103 on which the Intermediating Process 3 resides, so that the Provider Process 4 and the Intermediating Process 3 may interoperate 6.

Viewing Service Requests 53 allows the Provider 113 to see current Service Requests 23, 53. The Provider 113 may only see Service Requests 23, 53 when they are logged on 51 and connected 52. In one embodiment, the Service Requests 23, 53 are filtered, providing the Provider 113 with a sub-sample of Service Requests 23, 53. The filtering of Service Requests 23, 53 may be done on the basis of the Provider's 113 rating, the Provider's 113 rank with respect to the rating of all Providers 113, service type, geographic area, hourly rate, and experience level. In one embodiment, the Service Requests 23, 53 are presented to the Provider 113 one at a time. In an alternative embodiment, the Service Requests 23, 53 may be accessed as a list.

The Provider 113 can then select 54 a Service Request 23, 53 to perform. The Provider's selection 54 is communicated 6 to the Intermediating Process 3. The Provider 113 must confirm acceptance of the Service Proposal 56. If the Provider 113 rejects, the Intermediating Process 3 will allow the Provider 113 to select 54 another Service Request 23, 53. In an alternative embodiment, if the Provider rejects 56 after selecting 54 a Service Request 23, 53, the Provider 113 may make a counter-proposal varying the rate of pay or the time of performance for a particular Service Request 23, 53. Access to varying the terms of a Service Request 23, 53 may be extended to Providers 113 on the basis of rating, number of completed bookings, or level of membership. The Intermediating Process 3 creates a User Service Proposal 25 for the Service Request 23, 53 selected 54 and confirmed 56 by the Provider 113.

In an alternative embodiment, the Provider 113 may select 54 more than one Service Request 23, 53, creating a plurality of Service Proposals 25 to a plurality of Users 213. Once a User 213 has accepted a Service Proposal 25 from the Provider 113, the Intermediating Process 3 responds with a confirmation request to the Provider 56. The confirmation to the Provider 56 is, generally, the first Service Request 23 that the Provider selected 54 for which the User 213 accepted a Service Proposal 26 from the Provider 113.

Once a Provider 113 has confirmed 56, the Intermediating Process 3 allows the Provider 113 to view details of the Service Request 23, 53 and tracks the Provider's location and progress 57, using the GPS in the Provider's 113 PED 112, 114. If the Provider is unable to timely arrive, the Provider Process 4 allows the Provider 113 to cancel the booking 57.

Arriving at service location 58 is an event that starts the billing period. In one embodiment, both the Provider 113 and User 213 must acknowledge the presence of the Provider 113 at the Service Request 23, 53 location. In an alternative embodiment, only the Provider 113 needs to acknowledge the presence of the Provider 113 at the Service Request 23, 53 location prior to the billing period beginning. In an alternative embodiment, the Intermediating Process 3 logs the arrival 58 when the GPS signal from the PED 112, 114 matches the geolocation of Service Request 23, 54 work site, and the billing period begins.

The completion of service 59 is an event. In one embodiment, both the Provider 113 and User 213 indicate to the Intermediating Process 3 that the work in the Service Request 23, 53 is complete 59 and the billing session stops. In an alternative embodiment, only the Provider 113 needs to indicate that the work in the Service Request 23, 53 is complete for the billing session to stop. In an alternative embodiment, the session automatically ends when the Provider 113 leaves the service location, based on a GPS signal. The completion event 59 triggers the payment processing 30 to the User 213 and the receipt of payment process 60 for the Provider 113. The Provider 113 is automatically paid via the Provider's Payment Preference 65. At the end of the job, the Provider 113 provides feedback 61 about the User 213, the service location, and the work performed. The Provider 113 may then repeat the process 18 or end the session 62.

The non-sequential process 8 of the Provider Process 4 allows the Provider 113 to access various information including, but not limited to, Provider bookings 63; Provider Profile 64; Provider Payment Preference 65; Provider earnings 66; notifications 67; and report a problem 68. Provider bookings 63 includes both current bookings and past bookings, which means the current Service Requests 23, 53 and past, completed Service Requests 23, 53, respectively. A Provider 113 may view past bookings and select the User 213 as “prefer” or “avoid.” The Intermediating Process 3 will notify 67 the Provider 113 of any Service Requests 23 from a preferred User 213. The Intermediating Process 3 will only show Service Requests 23 from avoid Users 213 when there are no other Service Requests 23 meeting the Provider's criteria.

Provider Profile 64 allows the Provider 113 to change information in the Provider's Profile 64, including service area geography, rate of pay, services provided, experience, insurance, and licensing. The Provider's Profile 64 allows a Provider 113 to rank types of service. For example, a Provider 113 may prefer to perform lawn mowing, but may also be willing to weed, rake, or prune. By ranking lawn mowing as the preferred service type, the Intermediating Process 3 will prioritize Service Requests 23 that feature lawn mowing.

Earnings 66 shows the Provider 113 their earnings for various periods of time, such as daily, weekly, monthly, or annually. Earnings 66 also shows the Provider 113 their current I-9 tax form and allows them to amend or change it.

Notifications 67 notify the Provider 113 about key aspects of the process, such as receipt of a Service Requests 53, a confirmed 56 booking, and the estimated time of arrive (“ETA”) for the Provider 113 on a job site. Notifications 67 allows a Provider 113 to advertise to potential Users 213. Certain types of service, such as gutter cleaning, chimney sweeping, and snow removal are seasonal and/or periodic, and lend themselves to advertising. Notifications 67 notify a Provider 113 on their current feedback from Users 213. Notifications 67 also informs the Providers about any software changes or changes in terms of service.

Report 68 a problem allows a Provider 113 to provide feedback concerning the Provider App, the terms and conditions of using the Provider App, or any other concern that the Provider 213 wishes to have addressed. In one embodiment, the Provider Process 4, as embodied in the Provider App, provides a list of problem types to facilitate the process.

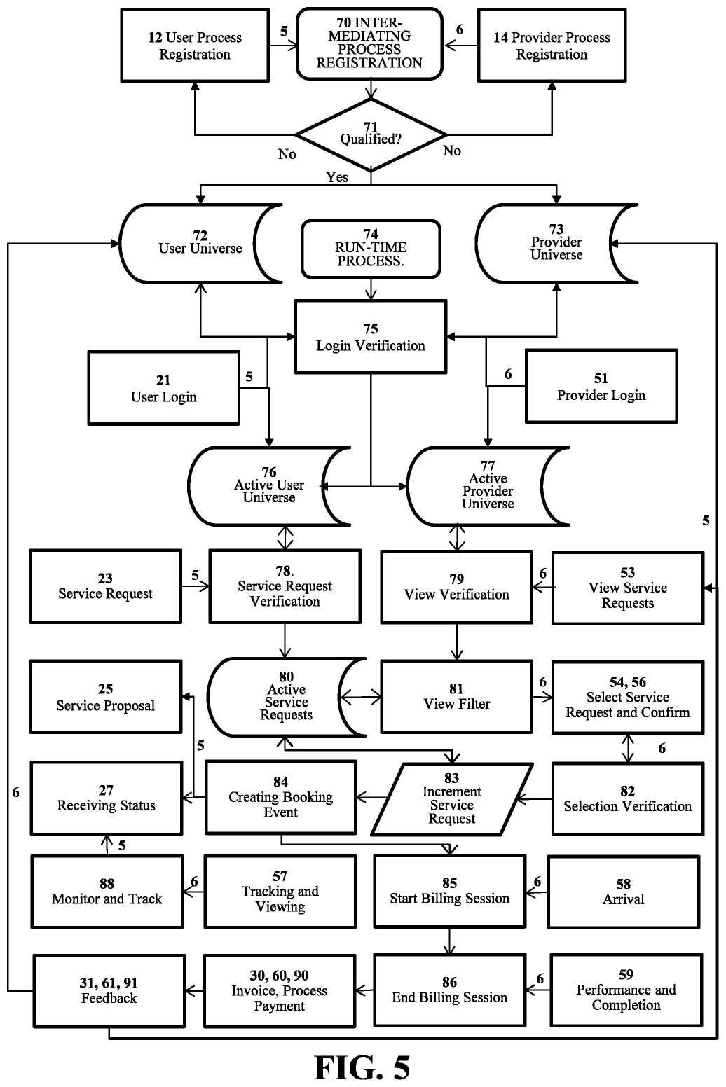

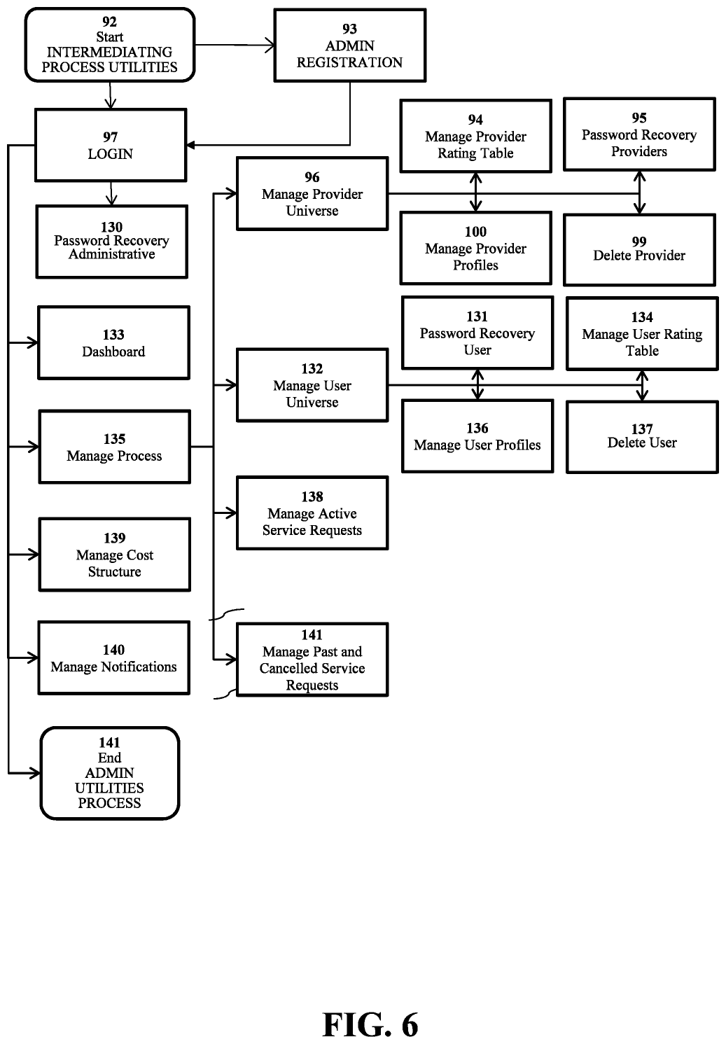

The Intermediating Process 3 has a run-time loop shown in FIG. 5 and a utility function in FIG. 6. The Intermediating Process 3 interacts with the User Process 2, and the Provider Process 4. Broadly stated, the Intermediating Process 3 matches Service Requests 23 from Users 213 with Providers 113 that can perform the Service Requests 53. The Intermediating Process 3 communicates 5, 6 with a plurality of UEDs 212, 214 and a plurality of PEDs 112, 114 using a combination of wi-fi, cellular communications, internet, and satellite 106, 107.

The Intermediating Process 3 has a registration 70 process that interoperates 5 with the User Process Registration 12. The registration process 70 of the Intermediating Process 3 also interoperates 6 with the Provider Process Registration 14. The Intermediating Process 3 qualifies 71 the User 213 from the User Process Registration 12 and places them in a User Universe 72. The Intermediating Process qualifies 71 the Provider 113 from the Provider Process Registration 14 and places them in a Provider Universe 73.

The Intermediating run-time loop 74 uses the User Universe 72 and the Provider Universe 73. Users 213 enter into the run-time loop 74 by logging in the User Process 21, which gets verified 75 by the run-time loop 74. Providers 113 enter into the run-time loop 74 by logging in the Provider Process 51, which gets verified 75 by the run-time loop 74.

The Intermediating Process 3 run-time loop 74 creates an Active User Universe 76 from logged 21 and verified 75 Users 213 from the User Universe 72. The Intermediating Process 3 run-time loop 74 creates an Active Provider Universe 77 from logged 51 and verified 75 Providers 113 from the Provider Universe 73.

The run-time loop 74 uses an Active Service Request Universe 80. A logged 21 User 213 may create a Service Request 23, which is communicated 5 to the run-time loop 74. The run-time loop 74 verifies the Service Request 78 and adds it to the Active Service Request Universe 80.

A logged 51 Provider 113 may View Active Service Requests 53 by communicating 6 with the run-time loop 74. The run-time loop 74 verifies 79 the Provider 113 with the Active Provider Universe 77. The run-time loop 74 filters 81 the Active Service Request Universe 80. The filtered view 81 provides the Provider 113 with Service Requests 23, 53 on the basis of one or more of the following: Provider's 113 rating, the Provider's 113 rank with respect to the rating of all Providers 113, service type, geographic area, hourly rate, and experience level. In one embodiment, the filtered view 81 presents the Provider 113 with Service Requests 23, 53 one at a time, starting with the most relevant Service request 23, 53. In another embodiment, the filtered view 81 presents the Provider 113 with a plurality of Service Requests 23, 53 in a list, ordered by the most relevant. In another embodiment, the filtered view 81 presents the Provider 113 all relevant Service Requests 23, 53 in a list, ordered by the most relevant. The filtered view 81 is communicated 6 to the Provider Process 4, from which the Provider 113 may select 54 and confirm 56 on or more Service Requests 23, 53, depending on the embodiment.

The Provider Process 4 confirmation 56 is communicated 6 to the Intermediating Process 3, which verifies the selection 82. The selected 54, confirmed 56, and verified 82 Service Request 23, 53 is incremented 83 out of the Active Service Request Universe 80, precluding other Providers 113 from selecting that particular Service Request 23, 53.

The run-time process 74 creates a booking event 84 from the Service Request 23, 53 and communicates 5 the Service Proposal 25 to the User. Tracking information 57 is communicated 6 from the PED 112, 114 to the run-time process 74. The run-time process 74 monitors and tracks 88 the Provider 113 and sends 5 status 27 updates to the User 213.

The arrival 58 of the Provider 113 at the work site is communicated 6 to the run-time process 74, which starts the billing session 85 associated with the booking even 84. Completion 59 of the Service Request 23, 53 is communicated 6 to the run-time process 74, which ends the billing session 86 associated with the booking event 84. This triggers invoicing 90, payment debiting 30 from the User 213, and payment 60 to the Provider 113. In one embodiment, these payments events all happen in real-time. In another embodiment, these payments are sequenced, with the invoicing 90 happening first, followed by debiting from the User 30, followed by the payment 60 to the Provider 113.

The run-time process 74 ends by asking feedback 31, 91 from the User 213 concerning the Provider 113 and communicates it to the Provider Universe 73. The run-time process 74 also asks for feedback 61, 91 from the Provider 113 concerning the User 213 and communicates it to the User Universe 72. The Provider may then iterate back to View Service Requests 53.

The Intermediating Process 3 also has a utility function, as seen in FIG. 6. The utilities process starts 92 with an administrative registration 93, followed by an administrative login 97. An administrative password recovery function 130 is included in the login 97.

The utility function 92 function allows the administrator of the Intermediating Process 3 to perform the following administrative functions: view status information through a dashboard 133; manage 135 the Intermediating Process 3; manage the cost structure 139; and manage the notifications 140. Managing 135 the Intermediating Process 3 entails managing the Provider Universe 96, managing the User Universe 132, managing Active Service Requests 138, and Managing Past and Cancelled Service Requests 141.

Managing Provider Universe 96 comprises managing Provider Rating table 94, Provider password recover 95, Provider Profile management 100, and deleting a provider 99. The administrator may manipulate the Provider Rating Table 94 by adding, changing, or deleting one or more ratings contained in the Provider Rating Table 94. The administrator may manipulate the Provider Profile 100 by adding, changing, or deleting one or more aspects of the Provider Profile 100.

Managing User Universe 132 comprises managing User Rating table 131, User password recover 134, User Profile management 136, and deleting a User 137. The administrator may manipulate the User Rating Table 131 by adding, changing, or deleting one or more ratings contained in the User Rating Table 131. The administrator may manipulate the User Profile 136 by adding, changing, or deleting one or more aspects of the User Profile 136. Manipulation 94, 100, 131, 136 is necessitated in order to prevent any scurrilous, profane, or inappropriate material; and to prevent any brigading or other attempts to affect the overall ratings provided by the invention 1.

I claim:

1. A system for matching service requests made by users with service providers comprising
a plurality of User Electronic Devices CUED″) each comprised of a display, an input, a power source, a processor, a random-access memory (“RAM”), access to a non-transitory, computer-readable memory, and an executable instruction set (“User App”) stored on the non-transitory, computer readable memory and capable of being executed by the UED processor;
a plurality of Provider Electronic Devices (“PED”) each comprised of a display, an input, a power source, a processor, a RAM, access to a non-transitory, computer-readable memory, and an executable instruction set (“Provider App”) stored on the non-transitory computer-readable memory and capable of being executed by the PED processor;
a server comprised of a processor, a communication chip sets, a RAM connected to the processor, an input, and an output;
a database comprised of a non-transitory computer-readable media that is accessible to the server processor;
communications channels between each UED and the server;
communications channels between each PED and the server;
and an executable instruction set (“Intermediating App”) stored on the database;
wherein a Service Request created by a User using a User App on a UED can be transmitted through the communications channels to the server;
wherein the Intermediating App will match the Service Request with a plurality of Providers who are capable of fulfilling the Service Request;
wherein one of the plurality of Providers using a Provider App on a PED transmits acceptance of the Service Request to the server; and
wherein the Intermediating App assigns the Service Request to the Provider.

2. A method of matching Service Requests with Service Providers comprising the steps of
using a User Process to generate a plurality of Service Requests;
using a Provider Process to identify a plurality of Providers willing to perform the Service Requests;
using an Intermediating Process to match the plurality of Service Requests with the plurality of Providers;
wherein the Intermediating Process comprises the steps of
identifying an Active User Universe from a User Universe;
identifying an Active Provider Universe from a Provider Universe;
accepting Service Requests from users in the Active User Universe;
creating a list of Active Service Requests from Service Requests made by Users in the Active User Universe;
verifying requests to view the list of Active Service Requests from Providers in the Active Provider Universe;
filtering the list of Active Service Requests and communicating the filtered list to the Provider Process;
verifying the selection of a Service Request from a Provider in the Active Provider Universe;
incrementing the list of Active Service Request to remove selections made by the Provider in the Active Provider Universe;
creating a booking event;
starting a billing session when the provider arrives at the place where the Service Request is to be performed;
ending the billing session when the provider completes the work in the Service Request;
processing payment from the user; and
providing payment to the provider.

3. The method of matching Service Requests with Service Providers of claim 2, wherein the User Process is comprised of the steps of using a UED;
connecting to the Intermediating Process;
creating a Service Request with the UED;
communicating the Service Request to the Intermediating Process;
receiving a booking event from the Intermediating Process and creating a Service Proposal from it;
receiving status information from the Intermediating Process;
having the Service Provider arrive to perform the Service Request;
having the Service Provider complete the Service Request;
processing payment for the service; and
providing feedback concerning the Service Provider.

4. The method of matching Service Requests with Service Providers of claim 3, wherein the Provider Process is comprised of the steps of
using a PED;
connecting to the Intermediating Process;
viewing Service Requests from the filtered list of Active Service Requests provided by the Intermediating Process;
selecting Service Requests from the filtered list of Active Service Requests;
communicating the selected Service Requests to the Intermediating Process;
viewing details of the booking event from the Intermediating Process and providing location information to the Intermediating Process;
arriving at the location at which the Service Request is to be performed;
communicating arrival to the Intermediating Process;
completing the work contained in the Service Request;
receiving payment; and
providing feedback on the Service Request and user.

5. The method of matching Service Requests with Service Providers of claim 4, further comprising the step of populating the Provider Universe with providers who have successfully completed provider registration, wherein the provider registration comprises, at a minimum, the creation of a Provider Profile and a payment preference.

6. The method of matching Service Requests with Service Providers of claim 5 further comprising the step of populating the User Universe with users who have successfully completed user registration, wherein the user registration comprises, at a minimum, the creation of a User Profile and a payment preference.

7. The method of matching Service Requests with Service Providers of claim 6, wherein the User Process further comprises the non-sequential steps of
viewing current and past bookings;
viewing User Profile;
viewing payment preferences;
receiving notifications; and
reporting a problem.

8. The method of matching Service Requests with Service Providers of claim 7, wherein the Provider Process further comprises the non-sequential steps of
viewing current and past bookings;
viewing Provider Profile;
viewing payment preferences;
viewing earnings;
receiving notifications; and
reporting a problem.

9. The method of matching Service Requests with Service Providers of claim 8, wherein the Intermediating Process further comprises the non-sequential steps of
recovering administrative passwords;
viewing dashboard metrics;
managing the Provider Universe;
managing the User Universe;
managing the Active Service Requests;
managing past and cancelled Service Requests;
managing the cost structure; and
managing notifications.

10. The method of matching Service Requests with Service Providers of claim 9, wherein managing the Provider Universe allows an administrator to manipulate the provider rating table; recover provider passwords; change provider profiles; and delete providers.

11. The method of matching Service Requests with Service Providers of claim 10, wherein managing the User Universe allows an administrator to manipulate the user rating table; recover user passwords; change user profiles; and delete users.

12. The method of matching Service Requests with Service Providers of claim 11, wherein the Intermediating Process Provider Universe contains the Provider Profile for every Provider in the Provider Universe.

13. The method of matching Service Requests with Service Providers of claim 12, wherein the Provider Profile contains at least the following attributes about the Provider: the Provider's skill areas, the types of jobs the Provider is willing to perform, the Provider's experience level, the Provider's geographic work areas, the Provider's hourly rate, and the Provider's licensing and insurance information

14. The method of matching Service Requests with Service Providers of claim 13, wherein the Intermediating Process filters the list of Active Service Requests for a Provider based off of the attributes contained in the Provider Profile.
